(19) United States
(12) Patent Application Publication
(10) Pub. No.: US 2005/0280343 A1
(43) Pub. Date: Dec. 22, 2005

(54) Lighting apparatus

(75) Inventor: Hiroshi Torihara, Mie (JP)

Correspondence Address: KEATING & BENNETT, LLP, 8180 GREENSBORO DRIVE, SUITE 850, MCLEAN, VA, 22102, US

(73) Assignee: SHARP KABUSHIKI KAISHA

(21) Appl. No.: 11/131,862

(22) Filed: May 18, 2005

(30) Foreign Application Priority Data
Jun. 17, 2004 (JP) 2004-180097

(51) Int. Cl. H01J 61/40

(52) U.S. Cl. 313/113

(57) ABSTRACT

A plurality of rare gas electric discharge lamps (14, 15) is disposed side by side on a side end surface of a light guide member (13) by making polarities of the rare gas electric discharge lamps (14, 15) coincident with each other. Poles (14a, 15a) of the rare gas electric discharge lamps (14, 15) at a grounding side thereof are electrically connected to each other. An inverter substrate (voltage control part) (21) is connected to the poles (14b, 15b) of the rare gas electric discharge lamps (14, 15) disposed at a voltage-applying side thereof. The inverter substrate (21) turns on one or both of the rare gas electric discharge lamps (14, 15) and changes a voltage to be applied to the rare gas electric discharge lamp (14). Thereby the luminance can be adjusted.

This nonprovisional application claims priority under 35 U.S.C. § 119(a) on Patent Application No(s). 2004-180097 filed in Japan on Jun. 17, 2004, the entire contents of which are hereby incorporated by reference.

### BACKGROUND OF THE INVENTION

1. Field of the Invention

The present invention relates to a mercury-free lighting apparatus and a liquid crystal display manufactured in consideration of environmental protection.

2. Description of the Related Art

In the car industry, owing to struggle for commercial supremacy in the market and a change in consumers' minds, a phenomenon has intensified in recent years that the achievement of an enterprise depends greatly on whether a new car wins a success. Reading a monthly chart of the major 10 makers introduced in a technical journal on cars, we get the feel with the skin that the conventional means of making a profit by a long seller is unwarrantable. In such a trend, makers' commercial cars manufactured as models of cars not polluting environment because of their strategic necessity have a good sale in recent years. Thereby the car makes have come to give attention to this phenomenon in the development of new cars and the business. Makers manufacturing electronic parts of cars are not unrelated with this trend. Thus Japanese makers, foreign car makers, Japanese major car makers, and makers manufacturing electric parts of cars are making research to develop a liquid crystal display which is mounted on a car body by taking anti-pollution of environment into consideration.

A car-discarding charge can be reduced and a car-discarding method can be selected owing to nonuse of mercury for the back light of a liquid crystal display mounted on an instrument panel of a car body or a rear seat thereof to navigate a car. That is, the mercury-free liquid crystal display decreases consumers' economic burden and contributes to the improvement of the brand images of the car manufactures.

For example, in the mercury-free electric discharge lamp disclosed in Japanese Patent Application Laid-Open No. 2001-243922 (patent document 1), the internal electrode is disposed at one end of the inside of the glass tube, whereas the external electrodes are wound spirally around the outer surface of the glass tube at predetermined pitches in the axial direction thereof. As the discharge medium inside the glass tube, instead of mercury gas, xenon gas or a mixture gas of the xenon gas and other rare gas is enclosed inside the glass tube. Each of the external electrodes is covered with a transparent resin film. In this electric discharge lamp, a voltage is applied to the internal electrode. Thereby discharge occurs between the internal electrode and the external electrodes to generate ultraviolet rays. The ultraviolet rays are converted into visible light through the coating film of the phosphor disposed on the inner surface of the glass tube. Thereby the electric discharge lamp emits light.

In the mercury-free lighting apparatus, having the mercury-free luminance adjustment range is used, disclosed in Japanese Patent Application Laid-Open No. 2003-178616, one mercury-free electric discharge lamp 2 is provided on both longer sides of the rectangular light guide member 1 as shown in FIGS. 14 and 15. The external electrode 2a of the electric discharge lamp 2 and the metal reflector 3 or the metal casing 4 are electrically connected to each other. The metal reflector 3 or the metal casing 4 is grounded.

The above-described mercury-free lighting apparatus has a problem that because a plurality of the mercury-free electric discharge lamps is provided along the light guide member, the wiring for each electrode is complicated. In addition, the total thickness of the module including the inverter for driving the mercury-free electric discharge lamps is large. Further the transformer is larger than that of conventional mercury electric discharge lamps. Therefore the liquid crystal display having the liquid crystal panel incorporated therein has a large thickness.

Nowadays, car manufacturers demand that the liquid crystal display has a dynamic range in its the surface luminance. More specifically, supposing that the luminance of the liquid crystal display in the daytime is 100%, car manufacturers demand that the luminance thereof can be adjusted in a wide range, i.e., can be reduced to a very small percentage of 1% to 2%. The above-described mercury-free electric discharge lamp has a problem in that it is incapable of making the luminance adjustment percentage much smaller than the conventional mercury lamp and that if the luminance of the liquid crystal display is reduced to an excessively low percentage, discharge occurs unstably, which affects the in-plane luminance distribution adversely. That is, in the liquid crystal display for use in the car, it is necessary to provide a particular light distribution in which the visual angle in the left-to-right direction is wide to keep a driver's seat and an assistant driver's seat at an equal and high luminance. In the above-described liquid crystal display, when the luminance adjustment percentage is set low, the balance of the in-plane luminance distribution cannot be kept when all the electric discharge lamps are turned on. Thus in the above-described liquid crystal display, stabilization of the luminance distribution is incompatible with the luminance adjustment in a wide range.

Patent document 1: Japanese Patent Application Laid-Open No. 2001-243922

Patent document 2: Japanese Patent Application Laid-Open No. 2003-178616

### SUMMARY OF THE INVENTION

The present invention has been made in view of the above-described problems. Therefore it is an object of the present invention to simplify wiring of a lighting apparatus including a mercury-free electric discharge lamp; make the lighting apparatus compact; and increase a luminance adjustment range without deteriorating luminance distribution when the luminance of the lighting apparatus is adjusted.

To solve the above-described problems, the present invention provides a lighting apparatus having a plurality of rare gas electric discharge lamps, each containing a rare gas including xenon, which are disposed side by side along a side end surface of a light guide member. In this construction, light emitted by the rare gas electric discharge lamps is incident on the light guide member from the side end surface thereof and leaves the light guide member in a shape of a plane from a light exit surface thereof. The rare gas electric discharge lamps are disposed by making polarities thereof coincident with each other. Poles of the rare gas electric discharge lamps at a grounding side thereof are electrically connected to each other.

The above-described construction allows the lighting apparatus to be mercury-free and wiring for each of the rare gas electric discharge lamps (hereinafter rare the gas electric discharge lamp is often referred to as merely electric discharge lamp) to be simple and hence the lighting apparatus to be manufactured at a low cost.

It is preferable that poles of the rare gas electric discharge lamps at a voltage-applying side thereof are electrically connected to each other.

The above-described construction allows wiring for each of the rare gas electric discharge lamps to be simple and the lighting apparatus to be manufactured at a low cost. Further because the poles of the rare gas electric discharge lamps at the voltage-applying side thereof are electrically connected to each other, the number of transformers for voltage-applying use is reduced. Thereby it is possible to simplify the construction of an inverter circuit for use in the electric discharge lamp and make the lighting apparatus compact and hence manufacture the lighting apparatus at a low cost.

The present invention provides a lighting apparatus including a plurality of rare gas electric discharge lamps, each containing a rare gas including xenon, which are disposed side by side along a side end surface of a light guide member. In this construction, light emitted by the rare gas electric discharge lamps is incident on the light guide member from the side end surface thereof and leaves the light guide member in a shape of a plane from a light exit surface thereof. A voltage control part is connected to the poles of the rare gas electric discharge lamps at the voltage-applying side thereof. The voltage control part turns on any desired number of the rare gas electric discharge lamps and changes a voltage to be applied to the rare gas electric discharge lamps. Thereby a luminance of the lighting apparatus can be adjusted.

In the above-described construction, as a method of adjusting the luminance of the lighting apparatus, when two electric discharge lamps are disposed side by side along the side end surface of the light guide member, one electric discharge lamp is turned off and the other is turned on to thereby perform PWM (pulse width modulation) light adjustment. Thereby the luminance can be adjusted in a wide range without deteriorating a luminance distribution. That is, unlike the conventional art, the luminance of the lighting apparatus of the present invention is adjusted not only by changing a voltage to be applied to the electric discharge lamps, but also by turning on desired number of electric discharge lamps. Thereby luminance-adjusting range is increased drastically to achieve a very low luminance adjustment percentage.

By connecting the voltage control part to an illumination switch of a car body, a signal for turning off one electric discharge lamp can be interlocked with ON of the illumination switch in the nighttime. Thereby it is possible to accomplish the luminance adjustment by automatically distinguishing the daytime and the nighttime from each other. The construction in which the signal for turning off one electric discharge lamp is synchronized with the illumination switch necessitates only the addition of a logic circuit to the inverter circuit of the electric discharge lamp. Thus this construction allows an automatic luminance adjustment function to be displayed at a low cost.

The lighting apparatus further includes a reflector reflecting light emitted by the rare gas electric discharge lamps and making the light incident on the light guide member. The reflector is composed of an unconductive reflection sheet and a diffusion reflection sheet bonded to the unconductive reflection sheet. The reflector is so disposed that the unconductive reflection sheet faces the rare gas electric discharge lamps.

As described above, the reflector has a layered construction. Thus even when the unconductive reflection sheet transmits a small amount of light therethrough, the diffusion reflection sheet reflects the light. Thereby light leakage can be prevented. Thus the light can be effectively utilized. It is difficult to process only one sheet because it is limp. But it is possible to perform a punching work easily for the reflector having the layered construction. Thus the reflector retains its shape and further can be manufactured non-defectively at a high yield. Since the sheet facing rare gas electric discharge lamps is unconductive, a parasitic capacity is hardly generated between the electric discharge lamp and the reflector. Thereby it is possible to prevent the drop of a voltage to be applied to the electric discharge lamp and the drop of the luminance.

The unconductive reflection sheet and the diffusion reflection sheet are bonded to each other through a transparent acrylic adhesive agent which does not turn into yellow.

When white light which transmits the reflector is viewed at an oblique side (large visual angle), a phenomenon that chromaticity shifts from white into yellow is known. But by using the above-described adhesive agent which does not turn into yellow even in long-time use, it is possible to prevent the chromaticity from shifting from white into yellow when the white light passes through the reflector. A mixture of an acrylic adhesive agent and a radical neutralizing agent added thereto is used as the transparent acrylic adhesive agent which does not turn into yellow.

The reflector is so bent that the reflector has a configuration surrounding the rare gas electric discharge lamps; and perforations are formed along a bent portion of the reflector.

The reflector has a larger thickness than the conventional reflector owing to the layered construction. Thus when the reflector is bent into a desired configuration, a higher rebound stress is generated in the reflector than in the conventional reflector. But the perforations are formed on the portion to be bent. Thereby the rebound stress is decreasingly generated in the reflector and the processability and workability can be improved.

A first prism sheet and a second prism sheet are layered on each other. The first prism sheet is so disposed that a projected surface of a prism part thereof faces downward toward the light guide member. The second prism sheet is so disposed that a prism part thereof faces a light exit direction. The second prism sheet is so disposed that a ridge of the prism part of the second prism sheet is orthogonal to a ridge of the prism part of the first prism sheet.

In this construction, the light emitted in the shape of a plane from the light guide member is refracted by the first prism sheet having prisms facing downward and spread in one direction. Therefore the lighting apparatus of the present invention has a luminance distribution (trapezoidal distribution) in which a high-luminance region is present at a wide angle in the one direction. The liquid crystal display having this lighting apparatus used as the back light thereof provides a display having a wide angle of field in one direction. For example, let it be supposed that the liquid crystal display is mounted on the instrument panel of the car body to navigate a car. When a luminance in a normal-line direction is standardized to 100% in the profile of a sectional luminance of the liquid crystal display, a luminance at 30 degrees in a left-to-right direction is set to not less than −20% nor more than +20%. Thereby the liquid crystal display covers a visual angle at a driver's seat, an assistant driver's seat, and a back seat and is capable of outputting an almost equal luminance in the above-described range, thus securing a favorable visibility.

The prism part of the second prism sheet faces the light exit direction and performs a light-condensing operation. The extension direction of the ridge of the prism part of the second prism sheet is orthogonal to that of the ridge of the prism part of the first prism sheet. Thereby the lighting apparatus has a luminance distribution in which a high luminance region is present at a small angle in the other direction orthogonal to the extension direction of the ridge of the prism part of the first prism sheet. The liquid crystal display having this lighting apparatus used as the back light thereof provides a display having a small angle of field in the other direction. For example, let it be supposed that the liquid crystal display is mounted on the car body. When a luminance in a normal-line direction is standardized to 100% in the profile of a sectional luminance of the liquid crystal display, a luminance at 50 degrees in a vertical direction is not more than 10%. That is, the liquid crystal display provides an almost triangular luminance distribution. Thereby during travel in the nighttime, it is possible to prevent an image displayed on the liquid crystal display from being reflected onto the front glass of the car body and secure safety during the travel in the nighttime.

It is preferable that the light guide member is wedge-shaped in such a way that the light guide member becomes gradually thinner from one side end surface thereof toward other side end surface thereof and that the rare gas electric discharge lamps are disposed side by side on only one side end surface of the light guide member.

In this construction, because the rare gas electric discharge lamps are provided on only one side of the light guide member, a small number of wires is used for the rare gas electric discharge lamps. Therefore the lighting apparatus can be made compact. Let it be supposed that a plurality of rare gas electric discharge lamps is disposed at opposed sides of the light guide member. In this construction, when the rare gas electric discharge lamp at one side is turned off, the luminance distribution deteriorates extremely and the display quality deteriorates. On the other hand, in the present invention, the rare gas electric discharge lamps are provided on only one side of the wedge-shaped light guide member. Thereby even when a desired number of the rare gas electric discharge lamps is turned off, the luminance distribution can be maintained favorably.

The present invention provides a liquid crystal display in which a transmissive liquid crystal panel is layered on the above-described lighting apparatus.

The present invention provides a liquid crystal display in which a semi-transmissive liquid crystal panel is layered on the above-described lighting apparatus.

As apparent from the above-described description, according to the present invention, a plurality of the rare gas electric discharge lamps disposed side by side is electrically connected with each other by making polarities of the rare gas electric discharge lamps coincident with each other. The above-described construction allows wiring for each of the electric discharge lamps to be simple and the lighting apparatus to be manufactured at a low cost. The poles of the rare gas electric discharge lamps at the voltage-applying side thereof are electrically connected to each other. This construction reduces the number of transformers, simplify the construction of the inverter circuit, and make the lighting apparatus compact.

The luminance adjustment is accomplished by adjusting the voltage to be applied to the rare gas electric discharge lamps and by turning on a necessary number of the rare gas electric discharge lamps. Thereby it is possible to achieve a very low luminance adjustment and widen the luminance adjustment range.

The first prism sheet is disposed with the projected surface of the prism part thereof facing downward. Thereby the liquid crystal display provides a luminance distribution (trapezoidal distribution) in which a high-luminance region is present at a wide angle in one direction. The second prism sheet is disposed with the projected surface of the prism part thereof facing upward by making the extension direction of the ridge of the prism part of the second prism sheet orthogonal to that of the ridge of the prism part of the first prism sheet. Thereby the liquid crystal display provides a luminance distribution (triangular distribution) in which a high luminance region is present at a small angle in the other direction.

### BRIEF DESCRIPTION OF THE DRAWINGS

FIG. 1 is a sectional view showing a liquid crystal display of a first embodiment of the present invention.

FIG. 2 is a perspective view showing an electric connection of rare gas electric discharge lamps.

FIG. 3 is a developed view showing a reflector.

FIG. 4 is a perspective view showing a reflector formed by bending it.

FIG. 5 is a sectional view showing the reflector by enlarging main parts thereof.

FIG. 6 is a top view showing sheets layered one upon another.

FIG. 7A is a sectional view taken along a line A-A of FIG. 6.

FIG. 7B is a sectional view taken along a line B-B of FIG. 6.

FIG. 8 is a graph showing a light distribution characteristic in a longer-side direction of a liquid crystal display.

FIG. 9 is a graph showing a light distribution characteristic in a shorter-side direction of the liquid crystal display.

FIG. 10 is a graph showing an all sky light distribution characteristic.

FIG. 11 is a perspective view showing an electric connection at a luminance-adjusting time.

FIG. 12 shows the relationship between a luminance adjustment percentage and a luminance adjustment ratio in the liquid crystal display.

FIG. 13 is a perspective view showing an electric connection of rare gas electric discharge lamps of a second embodiment of the present invention.

FIG. 14 is a perspective view showing a conventional lighting apparatus.

FIG. 15 is a top view showing the conventional lighting apparatus shown in FIG. 14.

### DETAILED DESCRIPTION OF THE PREFERRED EMBODIMENTS

The embodiments of the present invention will be described below with reference to drawings.

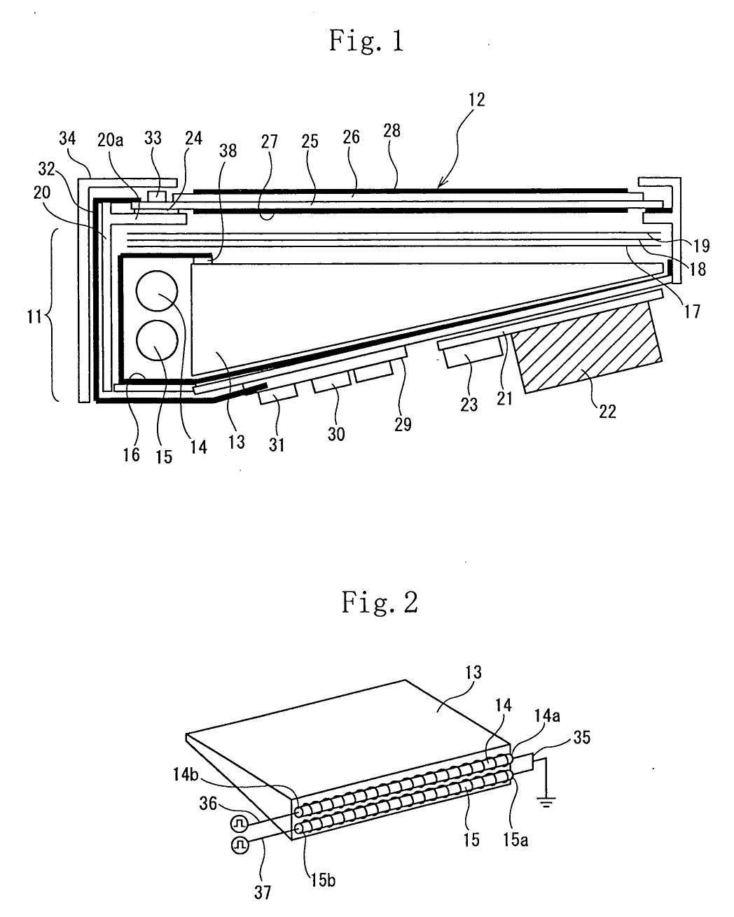

FIGS. 1 through 12 show a first embodiment.

A liquid crystal display 10 of the first embodiment has a lighting apparatus 11 which emits light in the shape of a plane and a transmissive liquid crystal panel 12 layered over the lighting apparatus 11.

The lighting apparatus 11 is rectangular in a plan view. Mercury-free rare gas electric discharge lamps (hereinafter referred to as merely electric discharge lamps) 14, 15 are vertically disposed on an end surface of a longer thicker side of a wedge-shaped light guide member 13. A reflector 16 surrounds the light guide member 13 and the electric discharge lamps 14, 15. Layered over the light guide member 13 are a first prism sheet 17 having prisms facing downward, a second prism sheet 18 having prisms facing upward, and an optical sheet 19 composed of a film for selectively reflecting polarized light and the film is described later and bonded to the light-blocking louver film at the side of the light guide member thereof. A first casing 20 accommodates the first prism sheet 17, the second prism sheet 18, and the optical sheet 19. An inverter substrate 21 having a voltage control part is disposed at a lower surface of the inverter substrate 21. Mounted on the inverter substrate 21 are a transformer 22 and a connector 23 of harnesses 36, 37 for applying a voltage to the electric discharge lamps 14, 15. As the method used for the inverter which drives the electric discharge lamps 14, 15, a separate excitation method is adopted. The inverter is of a particular type of forcibly applying a predetermined waveform to a primary circuit of the transformer 22 on the judgement of a microcomputer.

A double-coated tape 24 is provided on an inwardly projected flange 20a disposed at an upper side of the first casing 20 to set the liquid crystal panel 12 on the lighting apparatus 11. The liquid crystal panel 12 has a liquid crystal enclosed between an active matrix substrate 25 and a color filter substrate 26 thereof, and polarizing plates 27, 28 disposed on lower and upper surfaces thereof respectively. A driver chip 33 is mounted on an end portion of the active matrix substrate 25 of the liquid crystal panel 12. One end of a flexible wire (FPC) 32 is connected to the end portion of the active matrix substrate 25. The other end of the flexible wire 32 is connected to a connector 31 of a liquid crystal driving substrate 29 disposed on the lower surface of the lighting apparatus 11. Electric signals to be supplied to the liquid crystal panel 12 are controlled by a liquid crystal driving integrated circuit 30 mounted on the liquid crystal driving substrate 29 and distributed by the driver chip 33 through the flexible wire 32. A second casing 34 packages the lighting apparatus 11 and the liquid crystal panel 12.

The wedge-shaped light guide member 13 has a thickness of 8.8 mm at a side thereof where the electric discharge lamps 14, 15 are disposed and a thickness of 1.5 mm at a side thereof opposite to the side where the electric discharge lamps 14, 15 are disposed. A light guide member of VH5 grade manufactured by Mitsubishi Rayon Inc. is injection-molded to form the light guide member 13. Prisms are formed on a light exit surface of the light guide member 13 at pitches not more than 300 μm along the shorter side thereof. Circular arc-shaped prisms are formed on the lower surface of the light guide member 13 at pitches not more than 300 μm from approximately the middle of each of the electric discharge lamps 14, 15 disposed at the one longer side of the light guide member 13 toward the other longer side thereof. As the prisms become distant from the electric discharge lamps 14, 15, the pitches between the adjacent prisms become increasingly short.

As shown in FIG. 2, an electric discharge lamp of an inside-outside electrode type (disclosed in Japanese Patent Application Laid-Open No. 2001-243922) manufactured by Harrison Toshiba Lighting Inc. is used as the electric discharge lamps 14, 15. The electric discharge lamps 14, 15 have an outer diameter of Φ2.6 mm and a length of 158 mm. The electric discharge lamps 14, 15 are disposed side by side in a vertical direction in such a way that the polarity of the electric discharge lamp 14 and that of the electric discharge lamp 15 are coincident with each other.

Poles 14a, 15a of the electric discharge lamps 14, 15 at a grounding side thereof are grounded with the poles 14a, 15a connected to each other with a wire 35. Poles 14b, 15b of the electric discharge lamps 14, 15 at a voltage-applying side thereof are independent of each other. The harnesses 36, 37 for voltage-applying use are extended from the poles 14b, 15b respectively. A voltage control part of the inverter substrate 21 is capable of independently adjusting a voltage to be applied to the harnesses 36, 37. Thus the luminance of the lighting apparatus can be adjusted by turning on only one of the electric discharge lamps 14, 15.

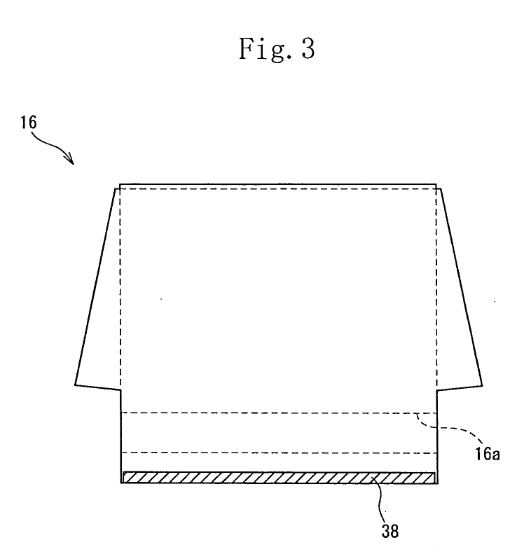

The special-purpose reflector 16 is used to effectively guide light emitted by the electric discharge lamps 14, 15 to the light guide member 13. The conventional reflector consists of one reflection sheet. On the other hand, as shown in FIGS. 3 through 5, in the first embodiment, the reflector 16 is composed of an unconductive reflection sheet 41 and a diffusion reflection sheet 43 bonded thereto through a transparent acrylic adhesive agent 42 which does not turn into yellow (hereinafter referred to as merely transparent acrylic adhesive agent 42).

As the unconductive reflection sheet 41, disposed at the inner side of the reflector 16, which directly reflects the light emitted by the electric discharge lamps 14, 15, a reflection film ESR manufactured by Sumitomo Three M Inc. is used. White foam PET E60L manufactured by Toray Industries Ltd. is used as the diffusion reflection sheet 43 disposed at the outer side of the unconductive reflection sheet 41. A mixture of TRICK-ETT (double-coated tape) produced by TRICK LIGHTING LABORATORY INC. and a radical neutralizing agent added thereto is used as the transparent acrylic adhesive agent 42. The transparent acrylic adhesive agent 42 and the diffusion reflection sheet 43 are unconductive as well as the unconductive reflection sheet 41.

The transparent acrylic adhesive agent 42 contains the radical neutralizer to prevent the transparent acrylic adhesive agent 42 from being turned into yellow owing to decomposition and bonding of resin chains which occur at a high temperature. More specifically, the radical neutralizing agent serves as a means for instantly neutralizing radicals generated owing to the decomposition of the resin chains by a chemical reaction to inhibit double bonding of carbons and preventing the transparent acrylic adhesive agent 42 from turning into yellow owing to thermal deterioration. Thereby the transparent acrylic adhesive agent 42 can be sufficiently durable for a long-term use. Hinder amine is used as the radical neutralizing agent in the first embodiment.

The reflector 16 is formed as the two-layer construction composed of the unconductive reflection sheet 41 and the diffusion reflection sheet 43 bonded to the unconductive reflection sheet 41 for the following two reasons: As one reason, the ESR (reflection film) used as the unconductive reflection sheet 41 has a high reflectivity, but transmits a little amount of light therethrough. To effectively utilize the light which has passed through the ESR, the white foam PET E60L used as the diffusion reflection sheet 43 and the unconductive reflection sheet 41 are bonded to each other. As the other reason, the ESR used as the unconductive reflection sheet 41 is so flexible that its processability is not easy. Thus to improve the processability of the material for the reflector 16, the unconductive reflection sheet 41 is backed with a stiff material.

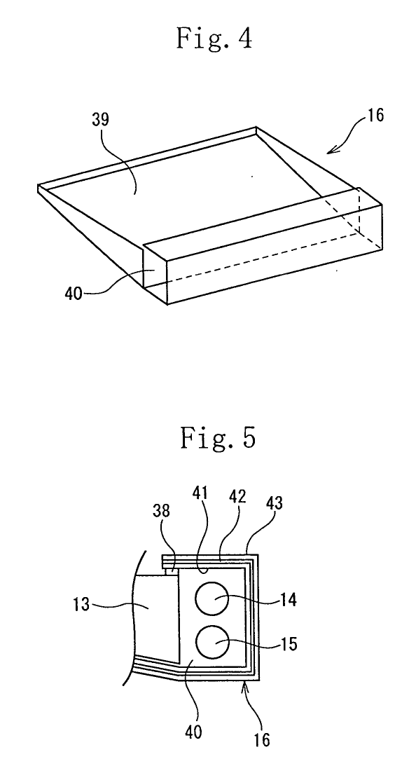

As shown in FIG. 4, the reflector 16 having the above-described construction is so bent that the reflector has a configuration surrounding the electric discharge lamps 14, 15. As shown in a developed view of FIG. 3, perforations are formed along a bent portion 16a with a cutting blade. As described above, the reflector 16 does not consist of one layer, unlike the conventional reflector. Thus the reflector 16 is thick. Consequently a high rebound stress is generated therein when it is bent. To reduce the rebound stress, the length of each portion to be perforated is elongated. In the first embodiment, the length of each portion to be perforated is set to 5 mm, and the length of each portion interposed between the portions to be perforated is set to 1 mm. The perforations can be formed on the reflector 16 by using a conventional perforation-forming method. By bending the reflector 16 at the bending portion 16a, a space 40 for accommodating the electric discharge lamps 14, 15 and a space 39 for accommodating the light guide member 13 are formed, as shown in FIG. 4.

As shown in FIG. 1, a transparent acrylic adhesive agent 38 (double-coated tape) which does not turn into yellow (hereinafter referred to as merely transparent acrylic adhesive agent 38) containing a radical neutralizing agent for improving heat resistance thereof is provided at an edge of the reflector 16 to bond the reflector 16 to an end of the upper surface of the light guide member 13. More specifically, as described above, the transparent acrylic adhesive agent 38 contains the mixture of the TRICK-ETT produced by TRICK LIGHTING LABORATORY Inc. and hinder amine added thereto as the radical neutralizing agent.

The transparent acrylic adhesive agent 38 (double-coated tape) is bonded to the reflector 16 before the transparent acrylic adhesive agent 38 is bonded to the light guide member 13. Thus the thinner part of the adhesive agent of the double-coated tape 38 is bonded to the reflector 16, whereas the thicker part of the adhesive agent thereof is bonded to the light guide member 13. As described above, the prisms are formed on the light exit surface of the light guide member 13. Thus it is advantageous to bond the thicker part of the adhesive agent of the double-coated tape 38 to the light guide member 13. The adhesiveness of the adhesive agent can be displayed in a certain period of time after it is bonded to an object. Thus the adhesive agent of the double-coated tape 38 has a sufficient anchoring effect, even though the thinner part of the adhesive agent of the double-coated tape 38 is used for the reflector 16.

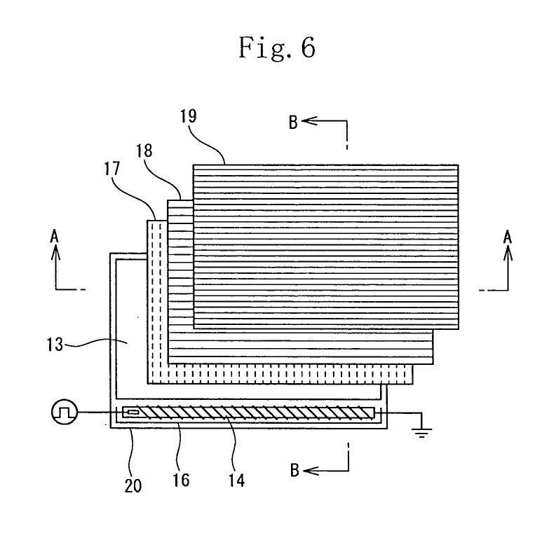

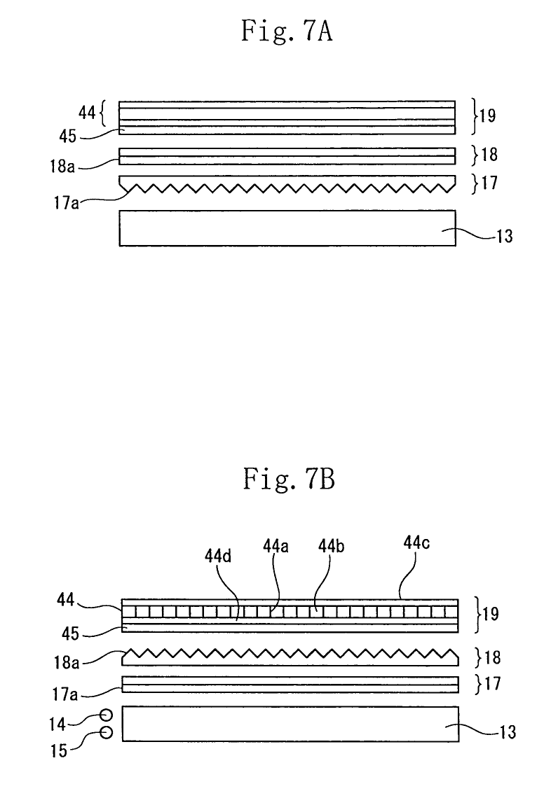

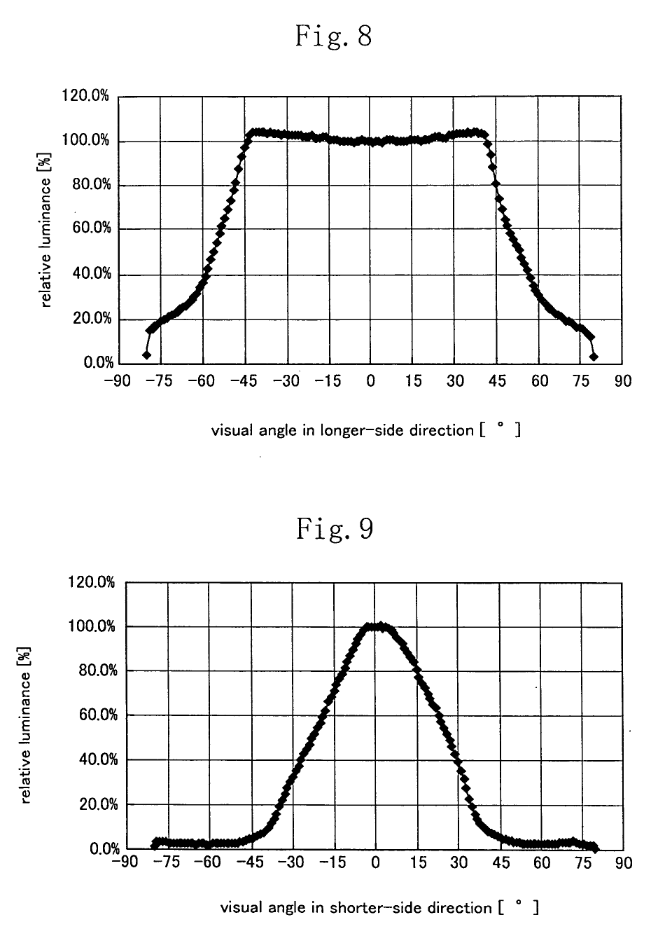

As shown in FIGS. 6, 7A, and 7B, as the first prism sheet 17 disposed directly over the light guide member 13, PC150S manufactured by Keiwa Inc. is used. The first prism sheet 17 is used with a prism part 17a thereof facing downward (toward the light guide member 13). The first prism sheet 17 serves as a means for refracting the light which has left the light guide member 13 at the prism part 17a thereof and spreading it in the direction of the longer side of the light guide member 13. More specifically, the first prism sheet 17 provides a trapezoidal luminance distribution (see FIG. 8) so that an angle of field becomes wide in the direction of the longer side of the liquid crystal display 10. In addition to the PC150S, PC150E or PC150MR manufactured by Keiwa Inc. may be used as the first prism sheet 17. The PC150E or the PC150MR has diffusibility to a higher extent than the PC150S and is thus suitable for improving the quality of the first prism sheet 17.

In the sense of the optical function of distributing light, a conventional diffusion sheet may be used with a prism part thereof facing downward, although the method of using the conventional diffusion sheet is a little different from that of the present invention. The conventional diffusion sheet is inferior in the light distribution performance, thus generating an unsharp synthesized vector. As the diffusion sheet used with a prism part thereof facing downward, it is possible to use BS01, BS04, BS300, BS500, BS700, PCES130, and KPC-ES manufactured by Keiwa Inc.; 100MXE, 100SXE, 100LXE, 100GM2, and 100TL4 manufactured by Kimoto Inc.; and D121, D124, D120, D122, and D117 manufactured by Tujiden Inc. The diffusion sheet has a small haze. The present inventors have found that an applicable haze is in the range of 25% to 88%.

The direction of the prism of the second prism sheet 18 is set almost parallel with the direction of the longer side of the liquid crystal display 10. More specifically, the second prism sheet 18 is so disposed that the ridge of the prism part 18a thereof is orthogonal to the ridge of the prism part 17a of the first prism sheet 17.

The second prism sheet 18 is used to refract light distributed by the first prism sheet 17 disposed under the second prism sheet 18 and condense the light to the center of the liquid crystal display 10 in the shorter-side direction thereof. That is, owing to the use of the second prism sheet 18, it is possible to provide a triangular luminance distribution (see FIG. 9) in which the angle of field becomes gradually smaller in the shorter side of the liquid crystal display 10 and improve the front luminance.

As the second prism sheet 18, BEF2 manufactured by Sumitomo Three M Inc. is used. BEF3, RBEF-8M, and PBEF-13M manufactured by Sumitomo Three M Inc. can be also used, because they have a light-condensing effect similar to that provided by the BEF2. But in the light-condensing performance, prism sheets having the commercial name of RBEF is inferior to prism sheets having the commercial name of BEF. Thus when an absolute luminance is required, prism sheets having the commercial name of RBEF are unsuitable. As such, the material for the second prism sheet 18 is appropriately selected according to a user's need.

In the optical sheet 19 disposed over the second prism sheet 18 and the first prism sheet 17, a film 45 for selectively reflecting polarized light is disposed integrally with the light-blocking louver film 44 at the lower side thereof. As shown in FIGS. 7A and 7B, the light-blocking louver film 44 is composed of light-absorbing layers 44a and light-transmitting layers 44b arranged periodically at predetermined pitches. The light-blocking louver film 44 is sandwiched between transparent substrates 44c and 44d, with the transparent substrate 44c disposed on an upper surface of the light-absorbing layers 44a and the light-transmitting layers 44b and with the transparent substrate 44d disposed on a lower surface of the light-absorbing layers 44a and the light-transmitting layers 44b. Therefore the light-blocking louver film 44 transmits light whose visual angle is not less than −θ nor more than +θ and intercepts light whose visual angle is less than −θ or larger than +θ.

When the liquid crystal display 10 is mounted on the car to navigate it, during its travel in the nighttime, an image displayed on the liquid crystal display 10 may be reflected onto its front glass and thus a real image and a virtual image may be mixedly present on the front glass. In this case, there is a fear that the driver's field of view deteriorates and an accident occurs. Therefore it is necessary to reduce the vertical angle of field to prevent the image displayed on the liquid crystal display 10 from being reflected onto the front glass.

As the film 45 for selectively reflecting polarized light, DBEF manufactured by Sumitomo Three M Inc. is used. The film 45 for selectively reflecting polarized light has a function of selectively reflecting polarized light, i.e., reflecting an s-polarized light component and transmitting a p-polarized light component. Owing to this optical function, the travel direction of some reflected light beams changes from a polarization direction to a transmission direction. Thereby the utilization efficiency of light can be improved. Actually, this optical function allows the luminance to increase by about substantially 30%.

In the first embodiment, as the optical sheet 19, LCF-plus manufactured by Sumitomo Three M Inc. is used, because it is capable of attaining the object of preventing the image displayed on the liquid crystal display 10 from being reflected onto the front glass and the object of improving the utilization efficiency of light.

The sheets 17, 18, and 19 are disposed at periodical pitches with respect to the optical axis of the polarizing plate 27 of the liquid crystal panel 12. Thus there is a possibility that an optical interference occurs between the periodical pitches of the sheets 17, 18, 19 and the pitches of pixels of the liquid crystal panel 12 to generate Moire on the display screen. To prevent the generation of the Moire by suppressing the optical interference, the vertical periodical direction of the sheets 17, 18, and 19 has an offset angle with, i.e., is set unparallel with the line of the pixels of the liquid crystal panel 12.

Actually in the first embodiment, an LCF-plus composing the optical sheet 19 disposed over the first prism sheet 17 and the second prism sheet 18 is set by rotating it at three degrees to 10 degrees to the left with respect to the line of the pixels of the liquid crystal panel 12. The BEF2 used as the second prism sheet 18 provided under the optical sheet 19 is disposed in parallel with the lateral line of the pixels of the liquid crystal panel 12. The PC150S used as the light-distributing first prism sheet 17 provided directly over the light guide member 13 is disposed in parallel with the longitudinal line of the pixels of the liquid crystal panel 12. That is, to prevent the optical interference from occurring between the periodical pitches of the sheets 17, 18, 19 and the pitches of pixels of the liquid crystal panel 12, it is absolutely necessary to set the uppermost optical sheet 19 (LCF-Plus) unparallel with the line of the pixels of the liquid crystal panel 12. But the first prism sheet 17 and the second prism sheet 18 are set unparallel with the line of the pixels of the liquid crystal panel 12 as necessary.

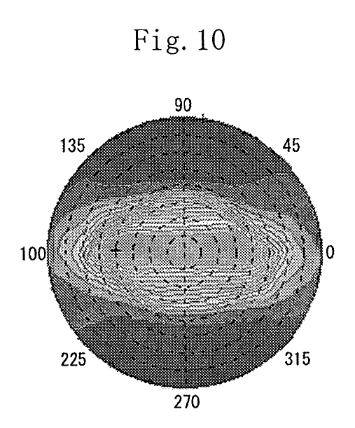

FIGS. 8 through 10 show a measured light distribution characteristic of the liquid crystal display 10 in which the lighting apparatus 11 having the first prism sheet 17, the second prism sheet 18, and the optical sheet 19 is incorporated. FIG. 10 shows the luminance distribution of an all sky light distribution image. FIGS. 8 and 9 show a sectional luminance profile obtained by cutting the all sky light distribution image of FIG. 10 in the longer-side direction (0 degree to 180 degrees) of the liquid crystal display 10 and the shorter-side direction (90 degree to 270 degrees) thereof.

As apparent from these figures, in the sectional luminance profile, the center of gravity of the luminance is present in the longer-side direction of the liquid crystal display 10 (left-to-right direction in car), whereas the luminance becomes extremely low at angles more or less than a certain angle in the shorter-side direction of the liquid crystal display 10 (vertical direction in car).

More specifically, as shown in FIG. 8, the liquid crystal display 10 has almost the same luminance in the range from −40 degrees to +40 degrees in the direction of the longer-side direction thereof, but has a trapezoidal luminance distribution in which the luminance becomes extremely low at angles less than −40 degrees and more than 40 degrees. In the case where the liquid crystal display 10 is mounted on the car to navigate it, the liquid crystal display 10 is desired to be seen at an equal brightness from a driver's seat, an assistant driver's seat, and a back seat. To satisfy this demand, the liquid crystal display 10 provides a light distribution in which the sectional luminance in the longer-side direction thereof is trapezoidal owing to the construction of each of the first prism sheet 17, the second prism sheet 18, and the optical sheet 19.

As shown in FIG. 9, in the shorter-side direction of the liquid crystal display 10, owing to the optical action of the light-blocking louver film 44 of the uppermost optical sheet 19, a range from −45° to +45° is the visual angle range. The actual visual angle range having preferable visibility is in a triangular distribution ranging from −30 degrees to +30 degrees. In the case where the liquid crystal display 10 is mounted on the car to navigate it, to prevent the image displayed on the liquid crystal display 10 from being reflected onto the front glass, it is necessary to set the luminance at a visual angle of 50 degrees in the vertical direction (shorter-side direction) to not more than 10% of the front luminance. FIG. 9 indicates this requirement is satisfied.

The mercury-free electric discharge lamps 14, 15 used in the first embodiment has a little smaller luminance-adjusting range than the conventional mercury lamp. As a means for solving this problem, the lighting apparatus 11 is so constructed that when a plurality of the electric discharge lamps 14, 15 is used, the electric discharge lamp 15 is turned off, whereas only the electric discharge lamp 14 is turned on to control the luminance. Thereby a wider luminance-adjusting range can be achieved than the conventional mercury-free electric discharge lamp.

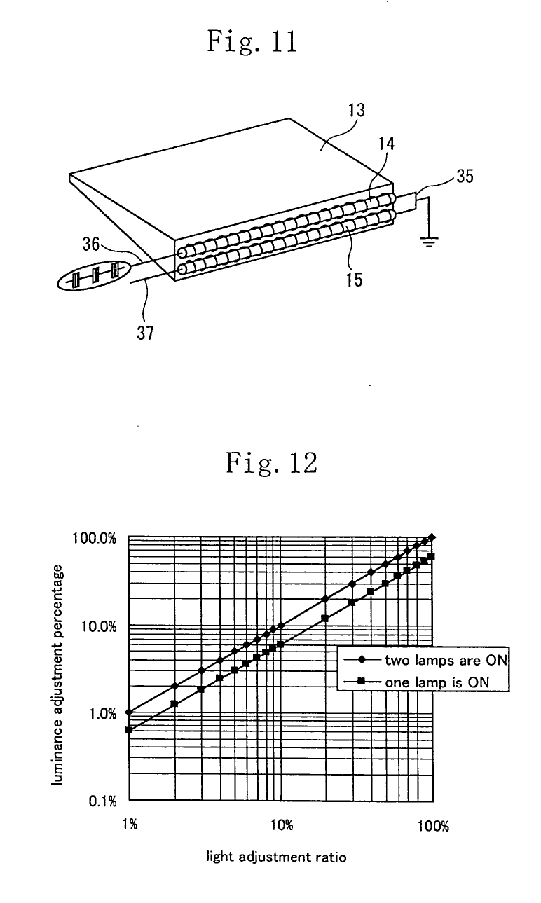

FIG. 11 shows an electric connection at a luminance-adjusting time. That is, the luminance of the lighting apparatus is adjusted (pulse width modulation), with the voltage control part of the inverter substrate 21 applying a voltage to the electric discharge lamp 14. At this time, a voltage is not applied to the electric discharge lamp 15 to turn it off.

In making the wide-range luminance adjustment, attention is given not to deteriorate the luminance distribution. In the conventional lighting apparatus having the electric discharge lamp disposed at each of the opposed sides thereof, when one of the electric discharge lamps is turned off, the luminance distribution deteriorates extremely and thus the display quality deteriorates. To solve this problem, in the first embodiment, a plurality of the electric discharge lamps 14, 15 is disposed at one side of the light guide member 13.

For example, when the liquid crystal display 10 is mounted on the car to navigate it, both the electric discharge lamps 14, 15 are turned on in the daytime. On the other hand, in the nighttime or in a tunnel, synchronously with an input signal indicating darkness, the lower electric discharge lamp 15 is turned off to adjust the luminance of the liquid crystal display 10 by turning on only the upper-side electric discharge lamp 14. Alternatively the upper-side electric discharge lamp 14 may be turned off. In this case, the luminance of the lighting apparatus is adjusted by turning on only the upper-side electric discharge lamp 15.

It is preferable to construct the following logic: Whether the daytime or the darkness (during travel in tunnel) is decided based on a signal outputted from a sensor provided on the car body. When the signal indicating the darkness is inputted to the inverter substrate 21, under the control of the voltage control part of the inverter substrate 21, a voltage is not applied to the lower electric discharge lamp 15. In addition, in the nighttime, when the lower electric discharge lamp 15 is turned off synchronously with the input of the signal to the inverter substrate 21, it is preferable to adopt a method of not applying a voltage to the lower electric discharge lamp 15 in association with turn-on of an illumination switch of the car.

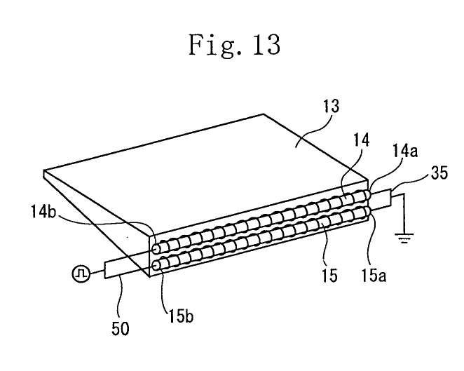

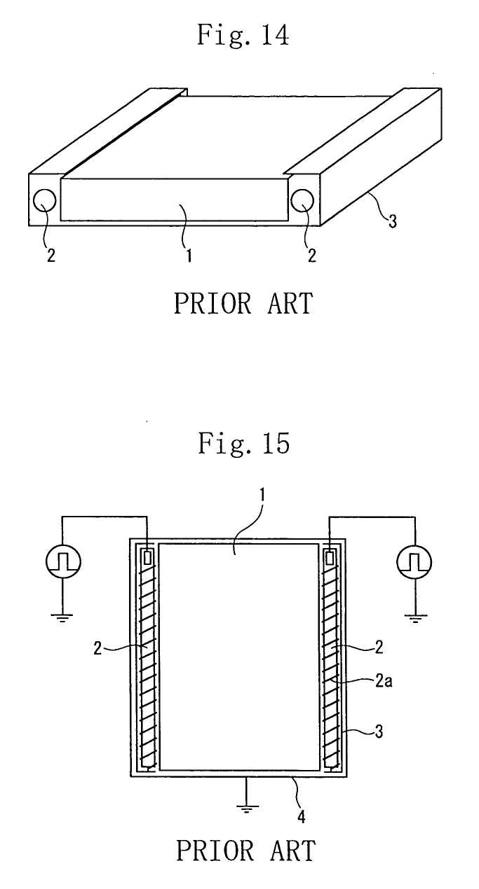

FIG. 12 shows the result of measurement of the relationship between the luminance adjustment percentage and the luminance adjustment ratio in the liquid crystal display 10. In the conventional lighting apparatus (FIG. 15) having the electric discharge lamp disposed at each of the opposed sides thereof, the maximum luminance when one electric discharge lamp is turned on is about 50% of the maximum luminance when two electric discharge lamps are turned on. On the other hand, in the present invention, the maximum luminance when only the lower electric discharge lamp 15 is turned on is about 60% of the maximum luminance when two electric discharge lamps are turned on. That is, when one electric discharge lamp is turned, the lighting apparatus 11 is capable of achieving a higher luminance than the conventional lighting apparatus. This is attributed to the compatibility of the electric discharge lamps with the wedge-shaped light guide member 13. The luminance adjustment ratio in the nighttime required by car manufacturers is 60% of the daytime luminance. Therefore the lighting apparatus 11 is very suitable for practical use.

The graph of FIG. 12 indicates that in a region where the luminance adjustment ratio is reduced to as low as 1% when one electric discharge lamp is turned on, luminance adjustment can be achieved at a percentage as low as 0.6% of the maximum luminance when two electric discharge lamps are turned on. Considering that the lower limit of the luminance adjustment ratio demanded by the car manufacturers is 1.5%, the liquid crystal display 10 is capable of achieving a wider luminance adjustment than the luminance adjustment ratio demanded by the car manufacturers. As described above, the liquid crystal display 10 is capable of adjusting the luminance in the range from 0.6% to 60% of the maximum luminance at the time when two electric discharge lamps are turned on. Owing to the benefit brought about by the wedge-shaped light guide member 13, the balance of the in-plane luminance distribution can be kept favorably, when one of the electric discharge lamps 14, 15 is turned off for the luminance adjustment. Thus the display quality of the liquid crystal display 10 does not deteriorate.

FIG. 13 shows the second embodiment of the present invention.

The second embodiment is different from the first embodiment in that the poles 14b, 15b of the electric discharge lamps 14, 15 at the voltage-applying side thereof are connected in parallel with a harness 50 for voltage-applying use.

The construction shown in FIG. 13 simplifies wiring for a plurality of the electric discharge lamps 14, 15 and hence reduces the manufacturing cost. Further because the poles 14b, 15b of the electric discharge lamps 14, 15 at the voltage-applying side thereof are connected with each other, it is possible to reduce the number of the transformers 22 for voltage-applying use and thus simplify the construction of the lighting apparatus and further miniaturize the construction of the inverter circuit for use in the electric discharge lamps 14, 15. Thereby the lighting apparatus can be manufactured at a low cost. The lighting apparatus of the second embodiment is similar to the lighting apparatus of the first embodiment in other constructions. Thus description of the other constructions of the second embodiment is omitted herein.

1. A lighting apparatus comprising:
a plurality of rare gas electric discharge lamps, each containing a rare gas including xenon, which are disposed side by side along a side end surface of a light guide member,
wherein light emitted by said rare gas electric discharge lamps is incident on said light guide member from said side end surface thereof and leaves said light guide member in a shape of a plane from a light exit surface thereof;
said rare gas electric discharge lamps are disposed by making polarities thereof coincident with each other; and
poles of said rare gas electric discharge lamps at a grounding side thereof are electrically connected to each other.

2. The lighting apparatus according to claim 1, wherein poles of said rare gas electric discharge lamps at a voltage-applying side thereof are electrically connected to each other.

3. A lighting apparatus comprising:
a plurality of rare gas electric discharge lamps, each containing a rare gas including xenon, which are disposed side by side along a side end surface of a light guide member,
wherein light emitted by said rare gas electric discharge lamps is incident on said light guide member from said side end surface thereof and leaves said light guide member in a shape of a plane from a light exit surface thereof;
a voltage control part is connected to said poles of said rare gas electric discharge lamps at said voltage-applying side thereof; and
said voltage control part turns on any desired number of said rare gas electric discharge lamps and changes a voltage to be applied to said rare gas electric discharge lamps, whereby a luminance of said lighting apparatus can be adjusted.

4. The lighting apparatus according to claim 1, further comprising a reflector reflecting light emitted by said rare gas electric discharge lamps and making said light incident on said light guide member,
wherein said reflector is composed of an unconductive reflection sheet and a diffusion reflection sheet bonded to said unconductive reflection sheet; and said reflector is so disposed that said unconductive reflection sheet faces said rare gas electric discharge lamps.

5. The lighting apparatus according to claim 3, further comprising a reflector reflecting light emitted by said rare gas electric discharge lamps and making said light incident on said light guide member,
wherein said reflector is composed of an unconductive reflection sheet and a diffusion reflection sheet bonded to said unconductive reflection sheet; and said reflector is so disposed that said unconductive reflection sheet faces said rare gas electric discharge lamps.

6. The lighting apparatus according to claim 4, wherein said unconductive reflection sheet and said diffusion reflection sheet are bonded to each other through a transparent acrylic adhesive agent which does not turn into yellow.

7. The lighting apparatus according to claim 5, wherein said unconductive reflection sheet and said diffusion reflection sheet are bonded to each other through a transparent acrylic adhesive agent which does not turn into yellow.

8. The lighting apparatus according to claim 4, wherein said reflector is so bent that said reflector has a configuration surrounding said rare gas electric discharge lamps; and perforations are formed along a bent portion of said reflector.

9. The lighting apparatus according to claim 5, wherein said reflector is so bent that said reflector has a configuration surrounding said rare gas electric discharge lamps; and perforations are formed along a bent portion of said reflector.

10. The lighting apparatus according to claim 1, wherein a first prism sheet and a second prism sheet are layered on each other;
said first prism sheet is so disposed that a projected surface of a prism part thereof faces downward toward said light guide member;
said second prism sheet is so disposed that a prism part thereof faces a light exit direction; and
said second prism sheet is so disposed that a ridge of said prism part of said second prism sheet is orthogonal to a ridge of said prism part of said first prism sheet.

11. The lighting apparatus according to claim 3, wherein a first prism sheet and a second prism sheet are layered on each other;
said first prism sheet is so disposed that a projected surface of a prism part thereof faces downward toward said light guide member;
said second prism sheet is so disposed that a prism part thereof faces a light exit direction; and
said second prism sheet is so disposed that a ridge of said prism part of said second prism sheet is orthogonal to a ridge of said prism part of said first prism sheet.

12. The lighting apparatus according to claim 1, wherein said light guide member is wedge-shaped in such a way that said light guide member becomes gradually thinner from one side end surface thereof toward other side end surface thereof; and said rare gas electric discharge lamps are disposed side by side on only one side end surface of said light guide member.

13. The lighting apparatus according to claim 3, wherein said light guide member is wedge-shaped in such a way that said light guide member becomes gradually thinner from one side end surface thereof toward other side end surface thereof; and said rare gas electric discharge lamps are disposed side by side on only one side end surface of said light guide member.

14. A liquid crystal display, wherein a transmissive liquid crystal panel is layered on the lighting apparatus according to claim 1.

15. A liquid crystal display, wherein a transmissive liquid crystal panel is layered on the lighting apparatus according to claim 3.

16. A liquid crystal display, wherein a semi-transmissive liquid crystal panel is layered on the lighting apparatus according to claim 1.

17. A liquid crystal display, wherein a semi-transmissive liquid crystal panel is layered on the lighting apparatus according to claim 3.
